(19) United States
(12) Patent Application Publication
(10) Pub. No.: US 2014/0136232 A1
(43) Pub. Date: May 15, 2014

(54) SYSTEM AND METHOD FOR BENCHMARKING HOSPITAL SUPPLY EXPENSES

(71) Applicant: Aspen Healthcare Metrics LLC, Englewood, CO (US)

(72) Inventors: Daniel Eugene Piro, Greenwood Village, CO (US); Lisa Dietz, Littleton, CO (US); Arie Dejong, San Antonio, TX (US)

(73) Assignee: MedAssets Performance Management Solutions, Inc., Englewood, CO (US)

(21) Appl. No.: 14/162,239

(22) Filed: Jan. 23, 2014

Related U.S. Application Data
(63) Continuation of application No. 11/602,718, filed on Nov. 21, 2006.

(51) Int. Cl. G06Q 50/22; G06Q 10/06

(52) U.S. Cl. CPC G06Q 50/22; G06Q 10/0631
USPC 705/2

(57) ABSTRACT

Embodiments of the present invention provide a system and method for determining a supply intensity metric (“SIM”) for benchmarking hospital supply expenses and for determining a supply expense target for opportunity identification based on the types and proportions of patients treated at a hospital. The SIM is a metric that may be used by hospitals to evaluate their supply chain or overall supply expenditures, and set goals for supply expense reduction. The SIM can be based on the number of patients in each DRG and an average supply expense for each DRG determined from a plurality of hospitals. A supply expense target may be based on, at least in part, a hospital's predicted inpatient supply expense, a non-chargeable expense, and a total outpatient supply expense.

### FIELD OF THE INVENTION

The field of the invention relates to a system and method for determining metrics and benchmarks for hospital supply expenses that account for the supply intensity of procedures a hospital performs.

### BACKGROUND

U.S. hospitals are under enormous pressure to better manage the cost of providing patient care. As hospitals examine their options for reducing costs, one of the main focus areas is their supply expense. Supply expenses generally comprise 15-30% of the total operating expense for a hospital. In order to develop a sound roadmap for operational improvement and cost reduction, hospitals seek metrics and benchmarks for guidance.

The commonly used metrics in hospital supply chain management include supply expense as a percentage of net patient revenue, supply expenses as a percentage of total operating expense, supply expense per adjusted patient days, and supply expense per adjusted discharge. Every day hospitals use these metrics and benchmarks with other hospitals to answer the questions “How are we doing?”, “How do we compare with others?” and “What else can we do better?”. However, since no two hospitals or integrated delivery network (IDN) hospitals have the same mix of physician specialists or perform the same combination of cases (either in type or proportion), comparing supply expense metrics between hospitals is difficult.

The most commonly endorsed method for normalizing supply chain metrics for inter-hospital comparisons of supply spend is the Medicare Case Mix Index (CMI). This has long been thought of as the best approach for putting hospitals and IDNs on a level playing field. While many hospital leaders acknowledge that the CMI is not ideal, it continues to be used routinely throughout the industry.

The major flaw with using the CMI to “normalize” hospital supply spend is that the CMI has never been intended to be used in such a manner. Medicare Case Weights were originally developed by Medicare as part of the Diagnostic-Related Group (DRG) Payment System in 1983. Case Weights are a relative value unit of measure, created to express overall resource consumption in labor, technology, supplies, etc. The costs of medical/surgical supplies, implants, and pharmaceuticals were not the primary considerations when specific case weights were first developed. And as published Aug. 1, 2006, the Center for Medical Science (CMS) will be re-weighting the DRG system to account for severity as it relates to overall resource consumption. This change will further confound the use of CMI to normalize for supply expenses. For example, consider the following two DRGs and their corresponding case weights: (1) DRG 387—Prematurity with Major Problems, case weight 3.14, average supply cost $696; (2) DRG 471—Bilateral or multiple Major Joint Procedures of the Lower Extremity, case weight 3.14, average supply cost $10,515. Although both DRGs have the same case weight, the average cost of direct patient supplies needed to treat patients in these DRGs is drastically different. Clearly, the type of clinical services offered by a hospital will have a significant impact on a hospital's annual supply spend and reimbursement. It typically does not make sense to compare the supply spend of a hospital that offers supply-intense procedures, such as joint surgery, with one that specializes in OB/GYN related diagnoses, such as DRG 387. These two patient populations do not have the same supply cost consumption.

A supply expense benchmarking methodology is needed that truly accounts for supply intensity for the patient population of a particular hospital. Furthermore, a methodology is needed that: (1) Factors in the cases a hospital performs and the associated supplies used, (2) includes actual supply costs per DRG, and (3) allows meaningful comparisons of supply spend for similar hospitals nationwide.

### SUMMARY OF THE INVENTION

Certain aspects and embodiments of the present invention provide (1) a system and method for determining a supply intensity metric (“SIM”) for a hospital to be used to define appropriate benchmarking groups and (2) a system and method to develop better targets for supply expense metrics. The SIM and the method to develop targets for supply expense metrics can account for the intensity of the supplies a hospital uses for treating patients in a hospital.

In one embodiment, the supply intensity metric (SIM) is calculated by determining an average supply expense for each DRG from a plurality of hospitals. The average supply expense for each DRG is multiplied by the total number of patients in that DRG. These values are summed and divided by the total number of patients for all DRGs.

In one embodiment, the average supply expense for each DRG may be determined by obtaining supply expense data for each DRG from a plurality of hospitals and finding the average supply expense for each DRG.

In one embodiment, a supply expense target is calculated by adding a predicted inpatient supply expense, a non-chargeable expense, and a total outpatient supply expense.

In one embodiment, the predicted inpatient supply expense may be calculated by determining a predicted supply expense for each DRG by multiplying an average supply expense for each DRG by a total number of patient days and adding the predicted supply expense for each DRG.

In one embodiment, the non-chargeable expense may be determined by multiplying the hospital's total number of patient days by a pre-determined value.

In one embodiment, the total outpatient supply expense may be received from the hospital. In another embodiment, the total outpatient supply expense may be calculated. An outpatient supply expense percentage is calculated by dividing a hospital's net outpatient revenue by a hospital's total net revenue. To calculate the outpatient supply expense, the total supply expense is multiplied by the outpatient supply expense percentage and the outpatient case intensity index. The outpatient case intensity index for a hospital is based on its SIM. The SIM for a hospital can be determined as described above.

In one embodiment, a hospital device comprising a processor and memory for storing hospital data is provided for sending hospital data over a network. A supply expense calculating device may be provided for receiving the hospital data. The supply expense calculating device may comprise a processor and memory for storing hospital data and an average supply expense of a plurality of DRGs. The supply expense calculating device memory may also comprise a calculation engine. The supply expense calculating device processor may be adapted to use the calculation engine to determine a SIM and supply expense benchmarks based, at least in part, on the predicted inpatient supply expense, the non-chargeable expense, and the total outpatient supply expense.

In one embodiment, the supply expense calculating device is a server.

In another embodiment, a server comprising a processor and a memory is provided for receiving hospital data over a network. The supply expense calculating device may be in communication with the server.

### BRIEF DESCRIPTION OF THE DRAWINGS

These and other features, aspects, and advantages of the present invention are better understood when the following Detailed Description is read with reference to the accompanying drawings.

FIG. 1 is a flow diagram of a method for determining a SIM for a hospital according to one embodiment of the invention.

FIG. 2 is a flow diagram of a method for determining a supply expense target for a hospital based on the SIM calculated in FIG. 1 according to one embodiment of the invention.

FIG. 3 is a flow diagram of developing targets for common supply expense metrics according to one embodiment of the invention.

FIG. 4 is a flow diagram for determining a target for a hospital's supply expense per adjusted patient discharge according to one embodiment of the invention.

FIG. 5 illustrates one embodiment of the communication of a hospital device with a supply expense calculating device through a network.

FIG. 6 illustrates one embodiment of the communication of a hospital device with a supply expense calculating device through a network and a server.

### DETAILED DESCRIPTION

Certain embodiments of the present invention comprise determining a supply intensity metric (“SIM”) for benchmarking hospital supply expenses and a supply expense target for opportunity identification based on the types and proportions of patients treated at a hospital. The SIM is a metric that may be used by hospitals to evaluate their supply chain or overall supply expenditures, and set goals for supply expense reduction. The SIM may be based on the number of patients in each DRG and an average supply expense for each DRG determined from a plurality of hospitals. A supply expense target may be based on, at least in part, a hospital's predicted inpatient supply expense, a non-chargeable expense, and a total outpatient supply expense.

In some embodiments, the SIM and supply expense target may be determined by a processor-based system. For instance, the supply expense target may be determined by adding the hospital's predicted inpatient supply expense, non-chargeable expense, and total outpatient supply expense together using the processor-based system. The inpatient supply expense may be determined based, at least in part, on an average supply expense for the DRGs. The average supply expense for each DRG may be determined by receiving supply expense data for each DRG from a plurality of hospitals and a plurality of patients (for example, over 100 hospitals and 600,000 patients), and calculating an average supply expense for each DRG. Using the average supply expense for each DRG, a predicted inpatient supply expense may be determined by multiplying the average supply expense for each DRG by a total number of patients treated by the hospital in a particular period of time, for example one year. A total predicted inpatient supply expense may be determined by adding the predicted supply expense for all DRGs.

The non-chargeable expense may be determined by multiplying the total number of patient days by a pre-determined value. The pre-determined value may be a dollar value associated with non-chargeable costs experienced by the hospital. The non-chargeable cost may be determined by averaging the non-chargeable costs for each patient day from a plurality of hospitals or may be obtained directly from the hospital for which the SIM is being determined.

The total outpatient supply expense may be received from the hospital. In another embodiment, the total outpatient supply expense may be calculated. In one embodiment, an outpatient supply expense percentage is calculated by dividing a hospital's net outpatient revenue by a hospital's total net revenue. To calculate the outpatient supply expense, the total supply expense is multiplied by the outpatient supply expense percentage and an outpatient case intensity index. The outpatient case intensity index for a hospital may be based on its SIM. The outpatient case intensity index according to one embodiment of the invention can range from 0.75 to 1. A hospital having a SIM at or below the national average SIM (for example $1450) may be assigned an outpatient case intensity index of 1. A hospital with a SIM at or above that of the top 5% of hospitals in the US (for example $2350) may be assigned an outpatient case intensity index of 0.75. The outpatient case intensity index according to some embodiments can be a linear scale between 0.75 and 1 that may be related to a SIM range for example a SIM range between $1450 and $2350. As the average SIM and SIM of the top 5% of hospitals changes over time, the SIM range used to linearly relate to the outpatient case intensity index may also change.

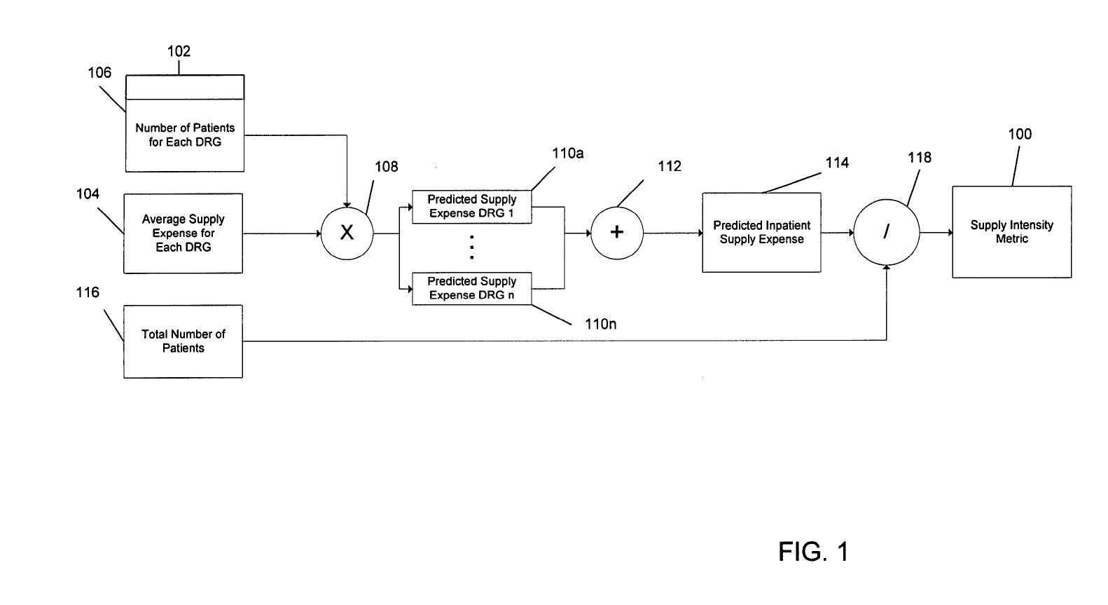

A flow diagram for determining a SIM 100 for a hospital according to one embodiment of the present invention is shown in FIG. 1. The SIM 100 is a metric that may be used to appropriately define a benchmarking group for hospitals during a particular period of time, for example one year. It is based on a variety of data 102 obtained from the hospital or a plurality of hospitals and related to the proportion of DRGs treated at a hospital. For instance, an average supply expense for each DRG 104 is multiplied 108 by the number of patients in each DRG 106 treated by a hospital during a period of time. This will determine a predicted supply expense for each DRG 110a-110n. The predicted supply expenses for each DRG 110a-110n are then added 112 to calculate a predicted inpatient supply expense 114. The predicted inpatient supply expense 114 is then divided 118 by the total number of patients 116 to calculate the Supply Intensity Metric 100.

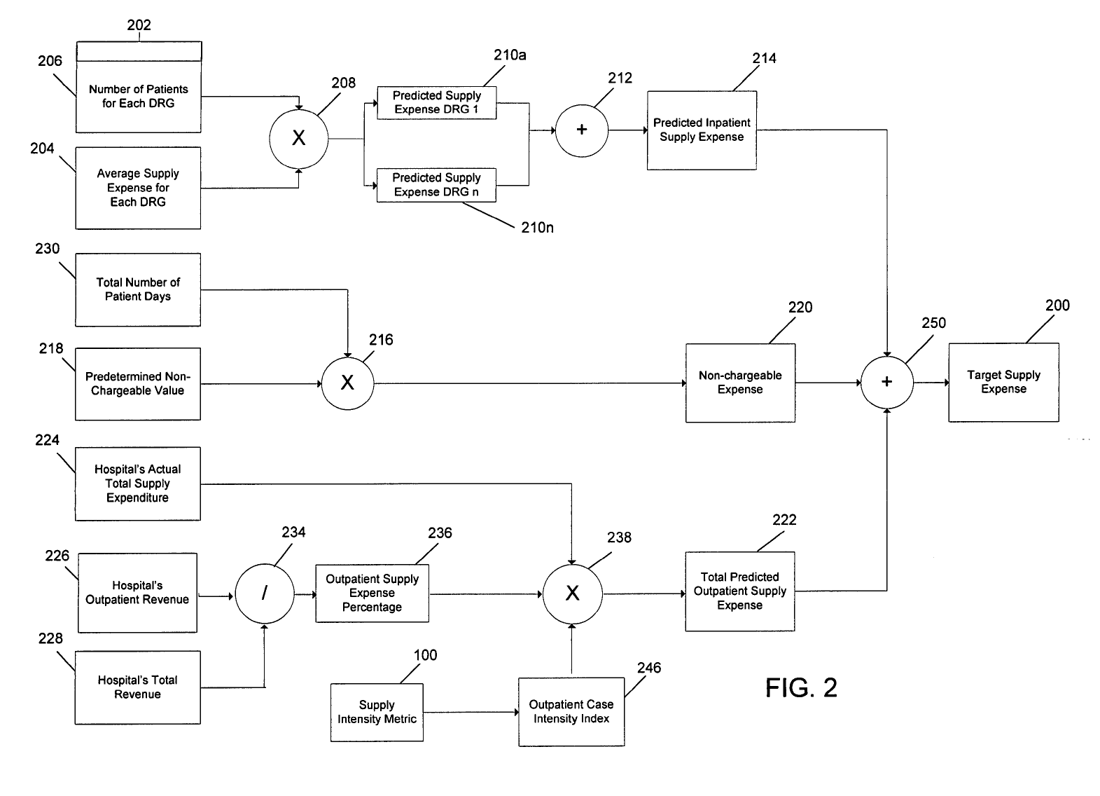

A flow diagram of one embodiment for determining a target supply expense 200 is shown in FIG. 2. It is based on a variety of data 202 obtained from the hospital or a plurality of hospitals and related to the proportion of DRGs treated at a hospital. For instance, an average supply expense for each DRG 204 is multiplied 208 by the number of patients in each DRG 206 treated by a hospital during a period of time. This will determine a predicted supply expense for each DRG 210a-210n. The predicted supply expenses for each DRG 210a-210n are then added 212 to calculate a predicted inpatient supply expense 214.

The total number of patient days 230 may also be multiplied 216 by a predetermined non-chargeable value 218 to determine a non-chargeable expense 220 associated with the hospital during the period of time. The predetermined non-chargeable value 218 may be a dollar value associated with non-chargeable costs experienced by the hospital. Examples of non-chargeable costs include telephone charges, hospital maintenance costs, and food service costs. The predetermined non-chargeable value 218 may be determined by averaging the non-chargeable costs for each patient day from a plurality of hospitals or may be obtained directly from the hospital for which the SIM is being determined.

In the embodiment illustrated in FIG. 2, a total outpatient supply expense 222 may be calculated from data associated with the hospital's actual total supply expenditure 224, the hospital's net outpatient revenue 226, a hospital's total net revenue 228, and the SIM 100, as calculated in FIG. 1. For instance, a hospital's net outpatient revenue 226 is divided 234 by the hospital's total net revenue 228 to determine an outpatient supply expense percentage 236. An outpatient case intensity index 246 may be determined using a linearly scaled system that estimates the outpatient case intensity index 246 based on the SIM 100. For example, the outpatient case intensity index 246 according to some embodiments can be a linear scale between 0.75 and 1 that may be related to a SIM 100 range. The hospital's total supply expense 224 is then multiplied 238 by the outpatient supply expense percentage 236 and the outpatient case intensity index 246 to determine the total outpatient supply expense 222.

A target supply expense 200 may then be calculated by adding 250 the predicted inpatient supply expense 214, the non-chargeable expense 220, and the total outpatient supply expense 222.

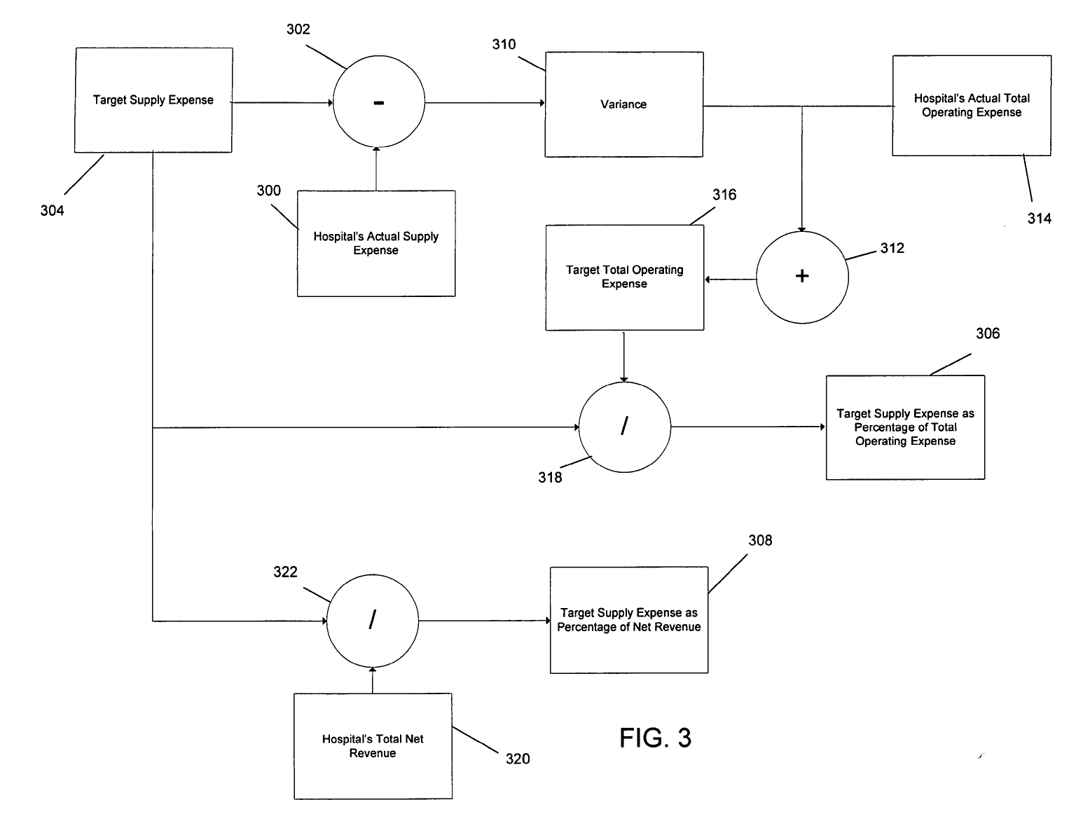

The SIM and the target supply expense may be used for analyzing and comparing hospital supply expenses and supply chain performance. The target supply expense may also be used to determine other metrics for analyzing hospital supply characteristics and performance. FIG. 3 illustrates developing targets for common supply expense metrics, such as: target supply expense as a percentage of total operating expenses 306 and target supply expense as a percentage of net revenue 308. The target supply expense 304 may be subtracted 302 from a hospital's actual supply expense 300 to calculate a variance 310. The target supply expense as a percentage of total operating expense 306 may be determined by first calculating a target total operating expense 316 by adding 312 the variance to the hospital's actual total operating expense 314. Then the target supply expense 304 is divided by the target total operating expense 316 to calculate the target supply expense as a percentage of total operating expense 306. The target supply expense as a percentage of net revenue 308 may be determined by dividing 322 the target supply expense 304 by the hospital's total net revenue 320.

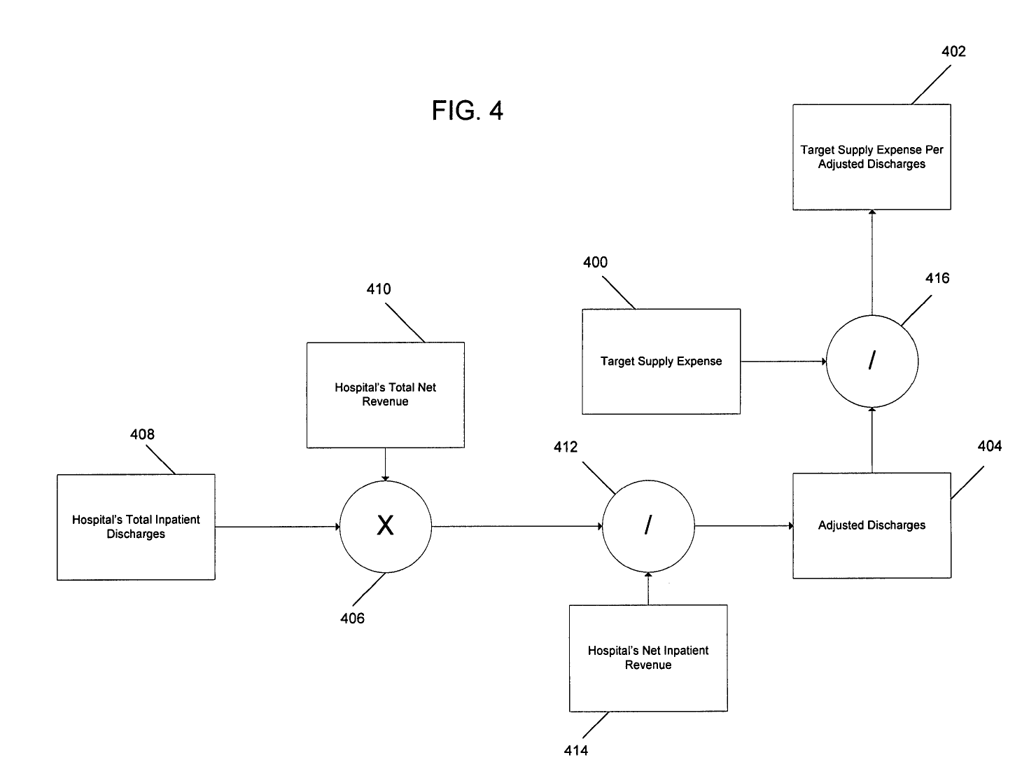

FIG. 4 shows one embodiment of using the target supply expense 400 to determine a target supply expense per adjusted discharge 402. To calculate a target supply expense per adjusted discharge 402, the adjusted discharges 404 for the hospital must be determined. The adjusted discharges 404 are determined by multiplying 406 a hospital's total inpatient discharges 408 by the hospital's total net revenue 410 and dividing 412 the result by the hospital's net inpatient revenue 414. After the adjusted discharges 404 are determined, the target supply expense 400 is then divided 416 by the adjusted discharges 404 to determine the target supply expense per adjusted discharges 402. A hospital may use the target supply expense per adjusted discharges 402 as a more realistic target for operational improvement and cost reduction. For example, the target supply expense per adjusted discharges 402 may be used as a benchmark for hospitals to compare with their actual supply expense.

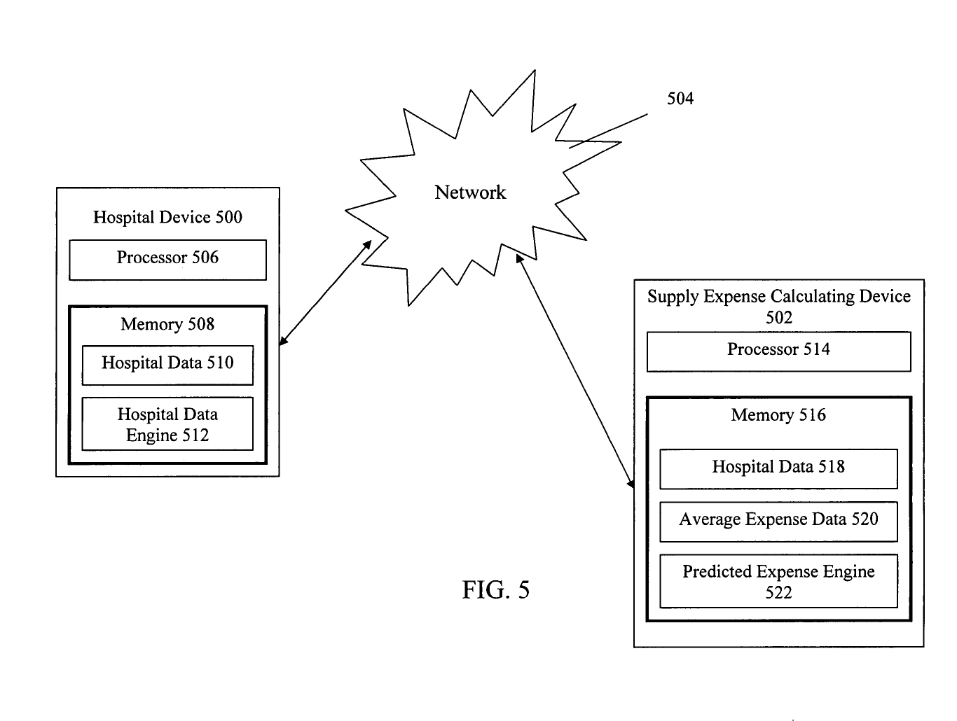

In some embodiments of the present invention, the SIM may be calculated using a processor-based system in communication with the hospital over a network. FIG. 5 illustrates one embodiment of a hospital device 500 in communication with a supply expense calculating device 502 over a network 504. The hospital device 500 may be a computer system and include a processor 506 and computer-readable medium, such as memory 508. Memory 508 may include computer-executable code, such as hospital data engine 512, and data, such as hospital data 510. The hospital data 510 may include data related to a hospital's discharges, DRGs, expenses, revenue, patient days, or any data that may be used to analyze the performance of a hospital's supply expenses. The hospital data engine 512 may send the hospital data to the network 504, analyze hospital data 510 to determine if the data is the desired data and in a desired form for sending to the supply expense calculating device 502, or otherwise. The processor 506 may access the memory 508 for executing the hospital data engine 512. The hospital device 500 may also receive data from the supply expense calculating device 502 through the network 504.

The network 504 may be any type of network adapted to allow two or more devices to send and receive data from each other or only from one device to the other. For example, the network 504 may be a communications network such as a local area network (LAN), wide area network (WAN), public switched telephone network (PSTN), or otherwise.

The supply expense calculating device 502 may be a computer system to receive hospital data 510 and other data, such as for example average supply expense per DRG data, through the network 504 and calculate a SIM or other metric to assist in analyzing a hospital's supply expenses. The supply expense calculating device 502 may include a processor 514 and computer-readable medium, such as memory 516. Memory 516 may include computer-executable code, such as predicted supply expense engine 522, and data, such as hospital data 518 received from the hospital device 500 and average expense per DRG data 520. The average expense per DRG data 520 may be received from another device (not shown) over the network 504 or inputted directly into the supply expense calculating device 502 by a user. The predicted expense engine 522 may calculate the SIM or other metric, such as a target supply expense, based on the hospital data 518 and average expense data 520. For instance, the processor 514 may access the predicted expense engine 522 to perform the calculations shown in FIGS. 1-4.

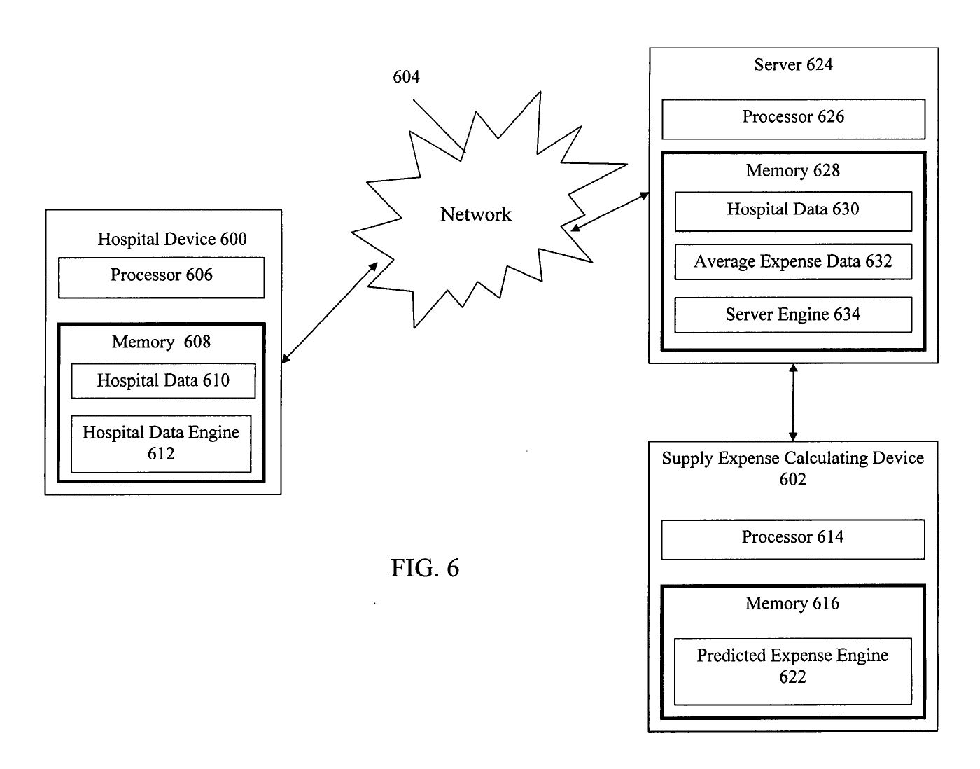

Illustrated in FIG. 6 is another embodiment of a hospital device 600 communicating with a supply expense calculating device 602 through a network 604. As shown in FIG. 6, the hospital device 600 sends hospital data to a server 624 through the network 604. The server 624 includes a processor 626 and computer-readable medium, such as memory 628. Memory 628 may include computer-executable code, such as a server engine 634 and data storage, such as hospital data storage 630 for storing hospital data received from the hospital device 600 and average expense data storage 632 for storing data related to the average expense per DRG. The server engine 634 may control access to the data stored on the server 624, or otherwise. The server 624 is in communication with a supply expense calculating device 602 that includes a processor 614 and a computer-readable medium, such as memory 616. Memory 616 may include computer-executable code, such as predicted expense engine 622 for determining a SIM or other metric, such as a target supply expense, to assist in analyzing a hospital's supply expenses. For instance, the supply expense calculating device 602 may access the hospital data and average expense per DRG data stored at the server 624 and the processor 614 may access the predicted expense engine 622 to determine the SIM or other metrics as illustrated in FIGS. 1-4. In some embodiments, the hospital data and average expense per DRG data may be stored in the supply expense calculating device 602.

The following is an example of utilizing one embodiment of the present invention to determine a hospital's SIM and using the SIM to analyze and evaluate the hospital's supply chain performance. A supply expense calculating device, such as a computer, receives data over one or more networks, such as telecommunications networks and/or the Internet, from a plurality of hospitals related to their total costs for each DRG treatment in a one year time period and calculates an average supply expense for each DRG. The supply expense calculating device also receives data from the hospital to be analyzed regarding the total number of discharges for each DRG and the total number of days patients spent in the hospital for each DRG. After receiving the hospital data and average supply expense data, the supply expense calculating device calculates an average length of stay (“ALOS”) for each DRG and a predicted supply expense for each DRG. The ALOS is calculated by dividing the total number of patient days by the total number of patients. The predicted supply expense for each DRG is calculated by multiplying the number of patients experienced by the hospital by the average supply expense for each DRG. For instance, the following Table 1 lists average supply expense for a selected group of DRGs, as calculated by the supply expense calculating device, sample data received from a hospital and the calculated average length of stay and predicted supply expense/DRG.

TABLE 1

| | | Average | | | | Predicted |
|---|---|---|---|---|---|---|
| | | Supply | | Total | | Supply |
| DRG | Description | Expense | Volume | Days | ALOS | Expense/DRG |
| 544 | Total Joint & Limb | $6,027 | 950 | 3,758 | 4 | $5,725,650 |
| 302 | Kidney Transplant | $18,749 | 225 | 537 | 2.4 | $4,218,525 |
| 480 | Liver Transplant | $24,065 | 108 | 1,105 | 10.2 | $2,599,020 |
| 481 | Bone Marrow | $10,461 | 215 | 4,309 | 20 | $2,249,115 |
| | Transplant | | | | | |
| 497 | Spinal Fusion | $11,025 | 172 | 1,788 | 10.4 | $1,896,300 |
| . | . | . | . | . | . | . |
| . | . | . | . | . | . | . |
| . | . | . | . | . | . | . |
| 319 | Kidney/Urinary | $149 | 1 | 2 | 2 | $149 |
| 382 | False Labor | $91 | 1 | 1 | 1 | $91 |
| 431 | Childhood Mental | $159 | 1 | 3 | 3 | $159 |
| 84 | Major Chest | $178 | 1 | 1 | 1 | $178 |
| | Trauma | | | | | |
| TOTAL | | | 51,898 | 245,920 | 4.7 | $85,437,218 |
| (all DRGs) | | | | | | |

A predicted inpatient supply expense may be calculated by adding the predicted supply expense for each DRG together. In the example illustrated in Table 1 above, the predicted inpatient supply expense for all DRGs, including DRG data not included in the table, is $85,437,218. The SIM ($1,646) is calculated by dividing the predicted inpatient supply expense ($85,437,218) by the number of discharges (51,898).

A non-chargeable expense is then calculated by the supply expense calculating device by adding the number of patient days for each DRG experienced by the hospital and multiplying the result by a predetermined non-chargeable value. For instance, the total number of patient days experienced by the hospital in the chart above is 245,920. The predetermined non-chargeable value ($85/day) is determined from an average for several hospitals. Therefore, the non-chargeable expense for the hospital is $20,903,200.

The supply expense calculating device may then determine an outpatient supply expense. The outpatient supply expense may be calculated given the following inputs: total supply expense of $156 million (MM), inpatient net revenue of $668MM, and outpatient net revenue of $366MM, total net revenue of $1,034MM and SIM of $1646. The outpatient supply expense percentage 35.4% is calculated from the revenue data ($366MM divided by $1034MM). The total outpatient supply expense is calculated by multiplying the total supply expense ($156MM) by the outpatient supply expense percentage (35.4%) and the outpatient case intensity index (0.95), for a total of $52.5M. The outpatient case intensity index (0.95) is derived from the SIM using a linear scale range from 0.75 to 1, in which 1 is assigned when the SIM is at or below a national average SIM (for example $1450) and 0.75 is assigned when the SIM is at or above the SIM of the top 5% of hospitals (for example $2350). Based on the linear scale between the ranges, a SIM of $1646 is assigned a case intensity index of 0.95.

The predicted inpatient supply expense, non-chargeable expense, and total outpatient supply expense are then added to determine the total target supply expense. For the example above, the total target supply expense during the past year is $85,437,218+$20,903,200+$52MM=$158,340,418. After determining the total target supply expense it may be compared to the hospital's actual total supply expense in order to provide the hospital and/or consultant with a indication of the performance of the hospital's supply chain. In this example, the total target supply expense ($158MM) is slightly higher than the actual supply expense ($156MM), which indicates that this facility is performing slightly ($2MM) better than the average facility with this particular supply intensity.

In addition, targets for traditional supply expense metrics can be calculated given the following inputs: total target supply expense of $158MM, total operating expense $831MM, inpatient net revenue of $668MM, outpatient net revenue of $366MM, total net revenue of $1,034MM, and total inpatient discharges of 245,920. A target for supply expense as a percentage of total operating expense is 18.1% ($158MM divided by ($831MM+$2MM)). A target for total supply expense as a percentage of net revenue is 14.6% ($158MM divided by $1,034MM). A target for supply expense per adjusted patient days is $396 ($158MM/380,630). Adjusted patient discharges (80,327) is calculated as total inpatient discharges multiplied by Total Net Revenue, divided by Inpatient Net Revenue, or 51,898*($1.034MM/$668MM). Hospital supply chain management and materials managers can use these targets and metrics to measure and improve hospital supply chain performance.

The foregoing description of embodiments of the invention has been presented only for the purpose of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated.

1-33. (canceled)

34. A method for determining a metric to facilitate supply expense benchmarking, comprising:
accessing, from a non-transitory computer-readable medium associated with a computing device, a supply expense representing the cost of supplies associated with a patient, a hospital, and a diagnostic related group;
determining, by the computing device, an average supply expense for a diagnostic related group based on the per-patient supply expense for the diagnostic related group and the number of patients in the diagnostic related group;
determining, by the computing device, a predicted patient supply expense for a diagnostic related group based on a plurality of supply expenses from a plurality of patients and a total number of patients; and
determining, by the computing device, a supply intensity metric for the diagnostic related group based on predicted patient supply expense and the average supply expense for comparison across multiple hospitals.

35. The method of claim 1 further comprising outputting, by the computing device, the determined supply intensity metric to a display device connected to the computing device.

36. The method of claim 1, wherein determining an average supply expense associated with each patient includes determining the supply expense based at least one of a central supply expense, a pharmacy expense, and a durable medical equipment expense.

37. The method of claim 1, wherein determining the average supply expense for the diagnostic related group includes generating a sum of the supply expenses associated with the diagnostic related group and dividing the sum by the corresponding the number of patients associated with the diagnostic related group.

38. The method of claim 1, wherein determining the predicted patient supply expense includes generating a sum of the supply expenses for a plurality of patients and dividing the sum by the total number of patients across multiple hospitals.

39. The method of claim 1, wherein determining a supply intensity metric includes dividing a predicted patient supply expense by the average supply expense for the total number of patients for the plurality of diagnostic related groups.

40. The method of claim 6, wherein determining the predicted patient supply expense further includes:
determining a non-chargeable expense by multiplying a total number of patient days by a pre-determined value;
determining a total outpatient supply expense; and
determining a target supply expense based, at least in part, on the predicted inpatient supply expense, the non-chargeable expense, and the total outpatient supply expense.

41. The method of claim 7, wherein determining the total outpatient supply expense comprises:
determining an outpatient supply expense percentage by dividing a hospital's net outpatient revenue by a hospital's total net revenue;
determining an outpatient case intensity index based, at least in part, on the supply intensity metric for the hospital; and
multiplying the hospital's actual total supply expenditure by the outpatient supply expense percentage and the outpatient case intensity index.

42. A computing device for computing a metric to facilitate supply expense benchmarking, the computing device comprising:
a memory for storing a supply expense representing a cost of supplies associated with a patient at a hospital and a diagnostic related group, and
a processor configured to execute instructions for:
determining an average supply expense for a diagnostic related group based on the per-patient supply expense for the diagnostic related group and the number of patients in the diagnostic related group;
determining a predicted patient supply expense for a diagnostic related group based on a plurality of supply expenses from a plurality of patients and a total number of patients; and
determining a supply intensity metric for the diagnostic related group based on predicted patient supply expense and the average supply expense for comparison across multiple hospitals.

43. The computing device of claim 9, wherein the computing device is further configured to output the determined supply intensity metric to a display device connected to the computing device.

44. The computing device of claim 9, wherein the supply expense associated with each patients includes at least one of a central supply expense, a pharmacy expense, and a durable medical equipment expense.

45. The computing device of claim 9, wherein, for each of the diagnostic related groups, the computing device determines the average supply expense by generating a sum of the supply expenses associated with the diagnostic related group and dividing the sum by the corresponding the number of patients associated with the diagnostic related group.

46. The computing device of claim 9, wherein the computing device determines the predicted supply expense by generating a sum of the supply expenses for a plurality of patients and dividing the sum by the total number of patients across multiple hospitals.

47. The computing device of claim 9, wherein the computing device further executes instructions to determine a supply intensity metric by dividing a predicted patient supply expense by the average supply expense for the total number of patients for the plurality of diagnostic related groups.

48. A non-transitory computer-readable medium embodying program code which, when executed, causes at least one computing device to perform steps comprising:
accessing, from a non-transitory computer-readable medium associated with a computing device, a supply expense representing the cost of supplies associated with a patient, a hospital, and a diagnostic related group;
determining, by the computing device, an average supply expense for a diagnostic related group based on the per-patient supply expense for the diagnostic related group and the number of patients in the diagnostic related group;
determining, by the computing device, a predicted patient supply expense for a diagnostic related group based on a plurality of supply expenses from a plurality of patients and a total number of patients; and
determining, by the computing device, a supply intensity metric for the diagnostic related group based on predicted patient supply expense and the average supply expense for comparison across multiple hospitals.

49. The computer-readable medium of claim 15 further comprising program code which, when executed, causes at least one computing device to output the determined supply intensity metric to a display device connected to the computing device.

50. The computer-readable medium of claim 15, wherein determining an average supply expense associated with each patient includes determining the supply expense based at least one of a central supply expense, a pharmacy expense, and a durable medical equipment expense.

51. The computer-readable medium of claim 15, wherein determining the average supply expense for the diagnostic related group includes generating a sum of the supply expenses associated with the diagnostic related group and dividing the sum by the corresponding the number of patients associated with the diagnostic related group.

52. The computer-readable medium of claim 15, wherein determining the predicted supply expense includes generating a sum of the supply expenses for a plurality of patients and dividing the sum by the total number of patients across multiple hospitals.

53. The computer-readable medium of claim 15, wherein determining a supply intensity metric includes dividing a predicted patient supply expense by the average supply expense for the total number of patients for the plurality of diagnostic related groups.
